(19) United States
(12) Patent Application Publication
(10) Pub. No.: US 2023/0278009 A1
(43) Pub. Date: Sep. 7, 2023

(54) DEGRADABLE ADSORBENT AND METHOD OF REMOVING IMPURITY FROM FLUID

(71) Applicant: Kureha America, Inc., Houston, TX (US)

(72) Inventors: Shunsuke Abe, Houston, TX (US); Mayu Komatsu, Houston, TX (US); Naomitsu Nishihata, Houston, TX (US)

(73) Assignee: Kureha America, Inc., Houston, TX (US)

(21) Appl. No.: 18/176,636

(22) Filed: Mar. 1, 2023

Related U.S. Application Data
(63) Continuation of application No. 63/316,883, filed on Mar. 4, 2022.

(51) Int. Cl. B01J 20/28; B01J 20/32; B01J 20/06

(52) U.S. Cl. CPC B01J 20/28026; B01J 20/3212; B01J 20/06; B01J 20/28054; B01J 20/28004; B01J 2220/4806

(57) ABSTRACT

A degradable adsorbent includes a porous degradable polymeric substrate, and nanoparticles bound to the porous degradable polymeric substrate. A method for removing an impurity from a fluid includes immersing a degradable adsorbent in the fluid containing the impurity, adsorbing the impurities in the degradable adsorbent, and disintegrating the degradable adsorbent in an aqueous solvent to produce a mixture containing the aqueous solvent, a degraded substrate and the impurity.

### BACKGROUND

A treatment method of a fluid containing an impurity, such as wastewater or contaminated air containing various contaminants, may include adsorbing the impurity with an adsorbent. An adsorbent may undergo post-fluid-treatment processes such as desorption, extraction and concentration processes to retrieve the impurity collected in the adsorbent. The adsorbent may then be disposed as a landfill or incinerated.

Aforementioned post-treatment processes may require substantial capital expenditure to build a suitable facility and equipment, and generally not be suitable in the areas with limited land space availability. Furthermore, the inclusion of the post-treatment processes increases the operational cost, and the disposal of used adsorbent by landfill or incineration may cause detrimental effects to the environment. Accordingly, there exists a need for continuing improvement of fluid treatment methods.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a degradable adsorbent including a porous degradable polymeric substrate, and nanoparticles bound to the porous degradable polymeric substrate.

In another aspect, embodiments disclosed herein relate to a method for removing an impurity from a fluid which includes immersing a degradable adsorbent in the fluid comprising the impurity, adsorbing the impurities in the degradable adsorbent, and disintegrating the degradable adsorbent in an aqueous solvent to produce a mixture comprising the aqueous solvent, a degraded substrate and the impurity. The degradable adsorbent includes a porous degradable polymeric substrate, and nanoparticles are bound to the porous degradable polymeric substrate.

Other aspects and advantages of the claimed subject matter will be apparent from the following description and the appended claims.

### DETAILED DESCRIPTION

The present disclosure generally relates to a degradable adsorbent comprising a porous degradable polymeric substrate (“polymeric substrate”) and nano-scale particles (“nanoparticles”) bound to the polymeric substrate. The degradable adsorbent may be used to remove an impurity from a fluid.

The present disclosure also relates to a method of removing an impurity from a fluid with a degradable adsorbent. The method may include immersing the degradable adsorbent in the fluid, adsorbing the impurity in the degradable adsorbent, and disintegrating the degradable adsorbent. The method allows the removal of hazardous substances or recovery of valuable materials from a fluid, such as wastewater or contaminated air, without generating contaminated solid waste materials which must be disposed of by processes such as incineration and landfill.

### Degradable Adsorbent

In the present disclosure, a “degradable adsorbent” refers to an adsorbent that disintegrates partially or completely upon exposure to a specific condition and is capable of adsorbing an impurity from a fluid. In one or more embodiments, the degradable adsorbent includes a polymeric substrate and nanoparticles bound to the polymeric substrate. The term “degradable” is defined as the ability of the adsorbent to be disintegrated upon exposure to a specific condition in a manner that an impurity adsorbed by the adsorbent may be retrieved due to the disintegration of the adsorbent. In one or more embodiments, the degradable adsorbent is disintegrated by severing molecular bonds of the adsorbent. In one or more embodiments, the degradable adsorbent is disintegrated by mechanically fracturing the adsorbent. In one or more embodiments, the degradable adsorbent is disintegrated by physically fracturing the adsorbent. In one or more embodiments, the degradable adsorbent is disintegrated by dissolving the adsorbent.

### Porous Polymeric Substrate

In one or more embodiments, the degradable adsorbent includes a polymeric substrate that is porous. The term “porous substrate” refers to a material having an internal structure comprising open spaces in a manner that open spaces are divided into substantially small pores. The polymeric substrate allows a fluid and particles to flow in and out of the polymeric substrate. The polymeric substrate has a substantially higher surface area compared to a non-porous, solid polymer material having the same apparent volume and dimensions due to presence of the pores. A fluid and particles smaller than the size of the pores may enter and exit the polymeric substrate.

In one or more embodiments, the pores are substantially small. In the present disclosure, the “substantially small” pores are defined as pores having dimensions such that when nanoparticles are bound to the polymeric substrate, the narrowest portion of the pore cross-section (“pore size”) has a distance of 10 nm to 1000 μm (1 mm). A larger pore size within this range generally provides a higher flow rate or thoroughput of the fluid, while a smaller pore size within this range generally provides a higher adsorption efficiency of the impurity. The pore side may be adjusted based on the requirements of a specific application. As an example, when the polymeric substrate is used in an adsorption column for continuous treatment of the fluid, the pore size may be adjusted by applying an appropriate amount of compressive force on the polymeric substrate.

In one or more embodiments, the degradable adsorbent includes pores having a pore size in a range from a lower limit selected from any one of 10 nm, 15 nm, 20 nm, 30 nm, 40 nm, 50 nm, 60 nm, 70 nm, 80 nm, 90 nm, 100 nm, 200 nm, 400 nm, 500 nm, 600 nm, 700 nm, 800 nm, 900 nm, and 1000 nm (1 μm), to an upper limit selected from any one of 5 μm, 10 μm, 50 μm, 100 μm, 200 μm, 300 μm, 400 μm, 500 μm, 600 μm, 700 μm, 800 μm, 900 μm, and 1000 μm (1 mm), where any lower limit may be paired with any upper limit.

In one or more embodiments, the polymeric substrate includes a structure such as foam, sponge, porous sheet, porous film, textile, porous tube, powder, and combinations thereof. In one or more embodiments, the textile is a fiber-based web of polymer. The textile may include woven fabric, knitted fabric, non-woven fabric, stitch-bonded fabric and the like. The polymeric substrate comprising particulates of powder may include fused particulates of powder. The polymeric substrate comprising powder may include a bed of particulates of the powder contained in a vessel designed to allow the fluid to enter and exit the vessel through the particulates while preventing the powder to be washed out of the vessel.

In one or more embodiments, the polymeric substrate includes a polymer that is degradable. In one or more embodiment, the polymer is one or more of hydrolysable, biodegradable, dissolvable, oxidizable, degradable in acid solution, degradable in basic solution, and the like. In one or more embodiments, the polymer includes a hydrolyzable functional group. Non-limiting examples of the hydrolyzable functional group include urethane, ester, amide, carboxyl, hydroxyl, silyl, acid anhydride, acid halide and the like. The polymer may include combinations of the hydrolyzable functional group.

Non-limiting examples of the polymer may include urethane, natural rubber, isoprene, ethylene propylene, butyl rubber, styrene, acrylic, aliphatic polyester, chloroprene, thermoplastic polyester and thermoplastic polyamide, or combinations thereof. It will be understood that where a polymer is named, co-polymers of that polymer are also contemplated.

In one or more embodiments, the polymer includes a polymer selected from the group consisting of polyvinyl alcohol (PVA), polyester and polyurethane and combination thereof as the base polymer to form the polymeric substrate.

In one or more embodiments, the PVA includes a polymer having a vinyl alcohol unit, and a co-polymer obtained by saponifying a polymer having a vinyl acetate unit, such as polymer produced by polymerizing vinyl acetate, with another monomer, such as olefin including ethylene. The co-polymer may have a vinyl alcohol unit obtained by substituting the acetate group of the vinyl acetate unit in the polymer with a hydroxyl group using a catalyst. Non-limiting examples of the degradable PVA may include a homopolymer of PVA, a co-polymer such as ethylene-vinyl alcohol (EVOH), and combinations thereof.

Non-limiting examples of the polyester may include aliphatic polyester such as polylactide/polylactic acid (PLA), polyglycolide/polyglycolic acid (PGA), poly-ε-caprolactone, polylactic-co-glycolic acid (PLGA), polyhydroxyalkanoates (PHA), and combinations thereof.

In one or more embodiments, PLA includes a homopolymer of L-lactic acid or D-lactic acid (PLLA, PDLA), a copolymer having L-lactic acid and D-lactic acid (PDLLA), and combinations thereof. The copolymer may include a repeating unit of L-lactic acid and D-lactic acid in the amount of at least 50% by mass, at least 75% by mass, at least 85% by mass, or at least 90% by mass. The PLA may be a stereocomplex type polylactic acid obtained by mixing poly-L-lactic and poly-D-lactic acid.

In one or more embodiments, the melting point of PLA is in a range from 130 to 180° C., and the glass transition temperature may be in a range from 60 to 65° C.

In one or more embodiments, PLA is capable of completely disintegrating in water at a temperature of 120° C. in 200 minutes. An example of such PLA may have an Arrhenius equation represented by:

$$ln ( t ) = 5847 ( \frac{1}{K} ) - 9.584$$

where t represents the time required, in terms of minutes, to hydrolyze PLA to a number average molecular weight of 1000, and K represents the temperature of water, in terms of Kelvin, in which PLA is immersed in to be hydrolyzed.

In one or more embodiments, PGA includes a homopolymer of glycolic acid consisting only of a glycolic acid unit (—OCH₂—CO—), a copolymer having a repeating unit of glycolic acid, and combinations thereof. The copolymer includes the repeating unit of glycolic acid in an amount of at least 50% by mass, at least 75% by mass, at least 85% by mass, at least 90% by mass, at least 95% by mass, or at least 99% by mass, or at least 99.5% by mass.

In one or more embodiments, the weight average molecular weight of PGA is in a range of 70,000 or more, or from 100,000 to 500,000, such as from a lower limit selected from any one of 100,000, 150,000, and 200,000 to an upper limit selected from 400,000, 450,000 and 500,000, where any lower limit may be paired with any upper limit.

In one or more embodiments, the melting point of PGA is 200° C. or more, such as 220° C., the glass transition temperature of 38° C. and a crystallization temperature of 90° C.

In one or more embodiments, PGA is capable of completely disintegrating in water at a temperature of 120° C. in 3 hours or less, when the thickness or the diameter of an article made by PGA is 1 mm or less.

Non-limiting examples of PGA may include Kuredux® available from Kureha Corporation.

In one or more embodiments, PLGA has a mass ratio of glycolic acid repeating units to lactic acid repeating units in a range from 99:1 to 1:99, 90:10 to 10:90, or 80:20 to 20:80.

In one or more embodiments, PHA has a melting point in a range from 40 to 180° C.

In one or more embodiments, the aliphatic polyester has a viscosity at a temperature of 270° C. and a shear stress of 122 sec-1 in a range from 100 to 10,000 Pas, 200 to 5,000 Pas, or 300 to 3,000 Pas.

In one or more embodiments, the polyurethane includes urethane bonds (—NH—CO—O—) in the molecule and may be obtained by condensing a urethane-bond containing compound with a compound having a hydroxyl group. As the isocyanate compound used to produce the polyurethane, aromatic (which may have a plurality of aromatic rings), aliphatic, and alicyclic di, tri, and tetra polyisocyanates, or mixtures thereof may be included. The polyurethane may include a polyester type having an ester bond in its main chain, and a polyether type having an ether bond in its main chain. In one or more embodiments, the polyurethane has an elastic body that combines the elasticity (softness) of synthetic rubber and the rigidity (hardness) of plastic, and may have excellent wear resistance, chemical resistance, and oil resistance, high mechanical strength and load resistance.

In one or more embodiments, the polymer includes polyvinyl butyral, polyvinyl formal, polyacrylamide (N, N-substituted product), polyacrylic acid, polymethacrylic acid, acrylamide-acrylic acid, methacrylic acid interpolymers, combinations thereof, and the like.

### Nano-Scale Particles

In one or more embodiments, the degradable adsorbent includes nanoparticles bound to the polymeric substrate. In one or more embodiments, the nanoparticles are bound to the surface of the polymer network in the inner portion of the polymeric substrate to provide a substantial amount of surface area covered with the nanoparticles for effective adsorption.

In one or more embodiments, the nanoparticles are a material selected from the group consisting of metals, non-metals, metal oxides, non-metal oxides, and combinations thereof. Non-limiting examples of the nanoparticles may include metalloids, such as silicone and boron, transition metals, such as copper, silver, iron, nickel, manganese, zinc, titanium, post-transition metals such as aluminum, non-metals such as carbon and selenium, alkali metals such as rubidium, alkaline earth metals such as calcium and magnesium, metal oxides such as copper oxide, alumina, zinc oxide nickel oxide, copper oxide, iron oxide, titanium oxide, manganese oxide and combinations thereof.

In one or more embodiments, the largest dimension of the nanoparticles is 1000 nm or less. The largest dimension of the nanoparticles refers to the distance between two furthest points of the nanoparticles. In one or more embodiments, the largest dimension of the nanoparticles is in range of 5 to 1000 nm, or 5 nm to 500 nm, such as a lower limit selected from any one of 5, 10, 20, 30, 40, 50, 60, 70, 80, 90, 100 nm, to an upper limit selected from 200, 300, 400, and 500 nm, where any lower limit may be paired with any upper limit.

In one or more embodiments, the nanoparticles have a variety of shapes. In one or more embodiments, the nanoparticles are spherical, cylindrical, cubic, prism, pyramidal, hemispherical, polygonal, disk-shape, or irregular shape.

In one or more embodiments, the nanoparticles are bound to the polymeric substrate with a variety of bonding mechanism. For example, the nanoparticles may be bound to the polymeric substrate with one or more of chemical bonding, mechanical bonding, and the like. In one or more embodiments, the nanoparticles are bound to the polymeric substrate with a sufficient force such that the nanoparticles do not detach from the polymeric substrate during the intended use of the degradable adsorbent.

In one or more embodiments, the nanoparticles are formed in situ on the surface of the polymeric substrate with an ion reduction process. The ion reduction process may include one or more of a thermal reduction and an electrochemical reduction. When the ion reduction is a thermal reduction, the conditions, including temperature, are maintained sufficiently to drive the reduction of ion precursors of the nanoparticles while maintaining the polymeric substrate in an undegraded state. Thus, the temperature may be sufficiently high for ion reduction and sufficiently low for polymeric substrate stability against degradation. It will be understood that conditions of the ion reduction may differ, for example in pH, from conditions that would drive degradation at a similar temperature.

In one or more embodiments, the nanoparticles are bonded to the surface of the polymeric substrate with an adhesive. In one or more embodiments, when the nanoparticles are bonded to the surface of the polymeric substrate with an adhesive, the polymeric substrate has the structure of a textile. As an example, the nanoparticles may be bonded to the textile by immersing the textile in a solution containing nanoparticles, an adhesive/binder and appropriate solvent, and then drying the textile to remove the solvent.

In one or more embodiments, the nanoparticles are fused onto the surface of the polymeric substrate by partially melting or softening the polymeric substrate.

In one or more embodiments, the degradable adsorbent includes additives. Additives may be incorporated into the degradable polymer used to produce the polymeric substrate, or introduced into the pores of the polymeric substrate and bound to the polymeric substrate along with the nanoparticles. Non-limiting examples of the additives may include polymers other than the degradable polymer, fillers, plasticizers, colorants, UV absorbers, antioxidants, processing stabilizers, weathering stabilizers, antistatic agents, flame retardants, mold release agents, fungicides and preservatives.

### Degradable Adsorbent Properties

In one or more embodiments, the degradable adsorbent has an apparent density, or bulk density in a range of 10 kg/m³ to 1000 kg/m³, such as a lower limit selected from any one of 10, 20, 30, 40, 50, 60, 70, 80. 190 100 kg/m³ to an upper limit selected from any one of 200, 300, 400, 500, 600, 700, 800, 900 and 1000 kg/m³, where any lower limit may be paired with any upper limit. Apparent density or bulk density is defined as a ratio of the mass of the material and the total volume that the material occupies. In case of porous materials, the total volume includes any internal space not occupied by the material.

In one or more embodiments, the degradable adsorbent has a percent porosity in a range of 5% to 99%, such as a lower limit selected from any one of 5, 10, 15, 20, 25, 30% to an upper limit selected from any one of 60, 70, 80, 90, 95, and 99%, where any lower limit may be paired with any upper limit. The porosity of a material is defined as a ratio of the volume of internal space not occupied by the material to the apparent volume of the material, which is the volume defined by the external boundary of the material.

Method of Removing an Impurity from a Fluid

In one or more embodiments, the method of removing an impurity includes immersing the degradable adsorbent in a fluid comprising an impurity. In the present disclosure, “immersing the degradable adsorbent” in a fluid refers to exposing and contacting the degradable adsorbent to the fluid such that the fluid enters and exits at least a portion of the degradable adsorbent. The fluid may be any liquid or gas or combinations thereof capable of including the impurity. The immersion of the degradable adsorbent may be full or partial. Examples of the fluid may include an aqueous liquid comprising water and the impurity, and air comprising the impurity. The impurity refers to any substance comprised in the fluid that differs from the fluid in which it is being contained. In one or more embodiments, the impurity includes a pollutant. The pollutant may comprise organic materials, such as polyfluoroalkyl substances (PFAS) including perfluorooctanoic acid (PFOA) and perfluorooctanesulfonic acid (PFOS), polychlorinated biphenyl (PCB), bisphenol A (BPA), dioxin, polycyclic aromatic hydrocarbons, formaldehyde or combinations thereof. In one or more embodiments, the pollutant includes inorganic materials including metallic materials such as lithium (Li), mercury (Hg), lead (Pb), arsenic (As), cadmium (Cd), chromium (Cr) and combinations thereof, and/or non-metallic materials such as nitrates, phosphates, sulfur oxide, nitrous oxide, and combinations thereof. In one or more embodiments, the impurity is selected from the group consisting of organic materials, inorganic materials and combinations thereof. As a result of immersing the degradable adsorbent in the fluid, the impurity included in the fluid enters the degradable adsorbent through the pores to be adsorbed.

In one or more embodiments, the method includes adsorbing the impurity in the degradable adsorbent. The impurity introduced into the pores of the degradable adsorbent may come in contact with the nanoparticles bound to the polymeric substrate of the degradable adsorbent. The impurity may then be adsorbed, or adhered onto the nanoparticles through various mechanisms. In one or more embodiments, the adsorption mechanism includes diffusion, electrostatic interaction, hydrogen bond, ion exchange and the like. Adsorption of the impurity results in the removal of the impurity from the fluid, and in case of one or more of wastewater and contaminated air treatment, the fluid free of impurity or reduced amount of the impurity may be discharged to the environment, treated further, or used for any suitable purposes.

In one or more embodiments, the method includes disintegrating the degradable adsorbent. In the present disclosure, “disintegrating” the degradable adsorbent refers to any process by which the degradable adsorbent is broken down fully or partially. In one or more embodiment, the degradable adsorbent is broken down in a manner such that the impurity adsorbed by the degradable adsorbent may be separated from the degradable adsorbent and retrieved. When the degradable absorbent disintegrates, the impurity may remain adsorbed to components of the degraded absorbent or may desorb from the components of the degraded absorbent. One or more of the nanoparticles may remain bound to one or more of the components when the degradable absorbent disintegrates. One or more the nanoparticles may debond from one or more of the components when the degradable absorbent disintegrates.

In one or more embodiments, the disintegrating is conducted in an aqueous solvent or through the use of water vapor. An “aqueous solvent” refers to any fluid comprising water and may be used as a medium to immerse the degradable adsorbent in the disintegration process. In one or more embodiments, the aqueous solvent is a liquid different from the fluid comprising the impurity, and in which the degradable adsorbent may be placed once the adsorbing of the impurity from the fluid is completed. In one or more embodiments, in case the fluid is an aqueous liquid, a portion of the aqueous liquid is used as the aqueous solvent to place the degradable adsorbent containing the impurity. In one or more embodiments, the aqueous solvent is acidic, neutral, or basic, and contains additives. The disintegrating may be conducted in a still aqueous solvent or flowing aqueous solvent, such as in an aqueous solvent subjected to agitation. In one or more embodiments, the aqueous solvent is a gas comprising water vapor, such as humid air.

In one or more embodiments, the disintegrating includes hydrolyzing the degradable adsorbent in the aqueous solvent. Hydrolysis is a chemical process in which a molecular compound is broken down due to the reaction with water. As an example, in hydrolysis reaction of polylactide (PLA), the ester group of the main chain of PLA may be cleaved by a water molecule, producing smaller oligomers and monomers. Such oligomers/monomers may have a substantially higher solubility in aqueous solution and as a result, the polymer disintegrates through dissolution of the oligomers/monomers.

In one or more embodiments, the hydrolyzing is conducted by a liquid aqueous solvent. In one or more embodiments, the hydrolyzing is conducted by water vapor, such as exposing the degradable adsorbent to humid air. The humid air may have a relative humidity (RH) % of at least 50, 60, 70, 80, 90% or RH % of 100%.

In one or more embodiments, the hydrolyzing process is conducted at an ambient temperature. In one or more embodiments, the hydrolyzing process is conducted at an elevated temperature in an aqueous solvent, such as a temperature in a range from a lower limit selected from any one of 30, 40, 50, 55, 60, 65, 70, 75, and 80° C. to an upper limit selected from any one of 90, 95, 100, 120, 140, 160, 180, 200, 250 and 300° C., where any lower limit may be paired with any upper limit. A liquid aqueous solvent having a temperature above 100° C. may be obtained by placing the aqueous solvent under an elevated pressure. An elevated pressure condition may be obtained by using a pressure vessel, an autoclave and the like.

In one or more embodiments. the hydrolyzing is conducted in the humid environment by humid air at an elevated temperature in a range from a lower limit selected from any one of 30, 40, 50, 55, 60, 65, 70, 75, and 80° C. to an upper limit selected from any one of 90, 95, 100, 120, 140, 160, 180, 200, 250 and 300° C., where any lower limit may be paired with any upper limit.

In one or more embodiments, the hydrolyzing is conducted for a duration in a range of 0.1 hours to 1000 hours, such as a lower limit selected from any one of 0.1, 0.5, 1, 2, 3, 4, 5 hours to an upper limit selected from any one of 10, 20, 30, 40, 50, 75, 100, 200,300, 400, 500 600, 700, 800, 900 and 1000 hours, where any lower limit may be paired with any upper limit.

In one or more embodiments, the disintegrating includes degrading the degradable adsorbent in an acidic, neutral or basic aqueous solvent. Disintegration of the polymeric substrate may be enhanced in an acidic or basic aqueous solvent. In case of disintegration process in acidic or basic aqueous solvent, acid or base may be added to the aqueous solvent to produce the acidic or basic aqueous solvent in which the degradable adsorbent may be placed. Due to the reaction of acid/base with the polymer molecules of the degradable adsorbent, the adsorbent breaks down and in case the broken-down molecules have higher solubility, dissolution of the broken-down molecules may occur, similar to the hydrolysis process.

In one or more embodiments, the disintegrating includes exposing the degradable adsorbent to a kinetic energy source. In one or more embodiments, the kinetic energy source is a form of kinetic energy containing sufficient energy to physically, mechanically, chemically or in any manner break down the polymer network and molecules of the degradable adsorbent upon exposure.

In one or more embodiments, the kinetic energy source includes various forms of electromagnetic waves such as ultraviolet (UV) waves (wavelength of 10⁻⁷ to 10⁻⁸ m), x-ray (wavelength of 10⁻⁸ to 10⁻¹¹ m), and gamma rays/radiation (wavelength of 10⁻¹¹ to 10⁻¹⁵ m), and acoustic waves such as ultrasound (frequency of greater than 20 kHz). In one or more embodiments, the kinetic energy source also includes particle radiation including alpha and beta radiation, plasma, and electricity. In one or more embodiments, the kinetic energy source also includes a mechanical energy source such as energy provided by processes to mechanically disintegrate the degradable adsorbent such as pulverizing, compounding, milling, cutting, grinding, or combinations thereof.

In one or more embodiments, the disintegrating includes exposing the degradable adsorbent to a microorganism, such as bacteria and fungi, to disintegrate the degradable adsorbent through biodegradation. Biodegradation is the breakdown of a substance by microorganisms through enzymic fractionation of the polymer molecules into smaller molecules such as oligomers and monomers.

In one or more embodiments, the disintegrating includes oxidizing the degradable adsorbent. In one or more embodiments, oxidizing is conducted by exposing the degradable adsorbent to oxygen under an elevated temperature condition, such as a temperature in a range from 80 to 300° C., such as a lower limit selected from any one of 80, 90, 100° C., to an upper limit selected from any one of 120, 140, 160, 180, 200, 250, and 300° C., where any lower limit may be paired with any upper limit.

In one or more embodiments, the disintegrating includes dissolving the degradable adsorbent. In one or more embodiments, dissolving may be conducted by placing the degradable adsorbent in an acidic, neutral or basic aqueous solvent in a liquid form. The dissolving may also be conducted in an aqueous solvent comprising water and other substances, such as water-miscible organic solvents including alcohols, acetone, tetrahydrofuran (THF), and combinations thereof.

In one or more embodiments, the disintegrating includes a combination of the aforementioned disintegrating processes. For Example, the mechanical degradation process may be combined with the hydrolyzing process or dissolving process, or the degradable adsorbent may be exposed to a plurality of the kinetic energy source simultaneously.

In one or more embodiments, disintegrating process produces a mixture which comprises a degraded substrate, nanoparticles, an impurity and an aqueous solvent. The “degraded substrate” refers to any components derived from the polymeric substrate of the degradable adsorbent as a result of the disintegrating process. The degraded substrate may include smaller molecules, such as molecules having a number average molecular weight of 1000 or less, that may be water-soluble. Such small molecules may include oligomers, dimers and/or monomers derived from the degradable adsorbent due to the severing of molecular bonds by a process such as hydrolysis. For example, hydrolysis of PLA may result in the generation of water-soluble lactic acid and/or lactic acid oligomer, and in such a case, lactic acid and/or lactic acid oligomer produced as a result of the hydrolysis may be considered as the degraded substrate.

The degraded substrate may also include a portion of the polymeric substrate which remains intact after the disintegrating process, in case of a partial disintegration. The degraded substrate may also include pieces of fractured polymeric substrate that are not small enough to be soluble in the aqueous solvent and remain as solid in the mixture. In one or more embodiments, the nanoparticles separate from the degraded substrate and impurity as a result of the disintegrating process and the nanoparticles are present in the mixture independently. In or more embodiments, the nanoparticles remain bound to the degraded substrate or the impurity.

In one or more embodiments, the mixture includes a liquid aqueous solvent in addition to the degraded substrate, nanoparticles and impurity. The liquid aqueous solvent may be present in the mixture as a result of the disintegrating conducted in the liquid aqueous solvent. In one or more embodiment, the liquid aqueous solvent is added to the mixture after the disintegrating process.

In one or more embodiments, the mixture includes water vapor in addition to the degraded substrate, nanoparticles and impurity. As previously noted, the disintegration process may be conducted by placing the degradable adsorbent in a humid environment and exposing the degradable adsorbent to humid air. The disintegration of the degradable adsorbent occurs as a result of the water vapor reacting with the degradable adsorbent.

In one or more embodiments, the mixture includes a liquid aqueous solvent and water vapor in addition to the degraded substrate, nanoparticles and impurity. For example, the disintegration process may be conducted by partially immersing the degradable adsorbent in the liquid aqueous solvent, and the portion not immersed in the liquid aqueous solvent may be exposed to humid air. The disintegration may occur both in the liquid aqueous solvent and in the humid air.

The concentration of impurity in the mixture may depend on the concentration of the impurity in the fluid, the amount of impurity adsorbed by the degradable adsorbent in the adsorbing process, and the amount of aqueous solvent used for the disintegrating process.

In one or more embodiments, the disintegrating process includes disintegrating the degradable adsorbent completely or partially. “Completely” disintegrating the adsorbent refers to disintegrating the polymeric substrate in a matter that the degraded substrate becomes fully soluble in the aqueous solvent and that the mixture does not contain any degraded substrate as a solid. “Partially” disintegrating the adsorbent refers to disintegrating the adsorbent in a matter such that a portion of the degraded substrate remains as a solid in the mixture. In one or more embodiments, the disintegrating includes partially disintegrating the degradable adsorbent such that the amount of the solid degraded substrate after the disintegrating process is 0.1 wt % to 99 wt % of the total amount of the degradable adsorbent before the disintegrating.

In one or more embodiments, the method further includes separating the impurity from the mixture. A suitable conventional separation process may be incorporated depending on the specific nature of the mixture. Examples of suitable separation process may include, but are not limited to, filtration, evaporation/distillation, crystallization, precipitation, adsorption/desorption, absorption, centrifugation, ion exchange and combinations thereof. The separation step may include separation of the impurity from nanoparticles.

In one or more embodiments, the method further includes collecting the impurity. In one or more embodiments, collecting the impurity includes physically gathering the impurity separated from the mixture, such as gathering the impurity collected on a filter or a distillation apparatus. In one or more embodiments, an additional process, such as desorption process is required in case an adsorption process is incorporated to separate the impurity from the mixture, for example.

In one or more embodiments, the method further includes destroying the impurity. The destruction step may include breaking down the impurity through combustion (incineration) or non-combustion methods. In one or more embodiments, the non-combustion methods include chemical, biological, plasma, mechanochemical, sonolysis, e-beam, UV, supercritical water oxidation, electrochemical, pyrolysis, gasification and combinations thereof. The destruction step may also include converting the impurity to another substance through a variety of processes.

In one or more embodiments, the method includes at least one of separation the impurity from the mixture, collecting the impurity and destroying the impurity, in addition to the immersing, adsorbing and disintegrating steps.

### EXAMPLES

The following examples are provided to illustrate embodiments of the present disclosure. The examples are not intended to limit the scope of the present invention, and they should not be so interpreted.

### Prophetic Example 1

An exemplary degradable porous adsorbent includes a foam of polyglycolic acid (PGA) as a polymeric substrate and iron oxide nanoparticles disposed on the polymeric substrate. The degradable adsorbent is immersed in an aqueous liquid containing perfluorooctanesulfonic acid (PFOS). The immersion process results in adsorption of PFOS onto the nanoparticles producing loaded absorbent. The PGA foam is then hydrolyzed by placing the loaded absorbent in water at a temperature of 100° C. for 6 hours. The PGA foam disintegrates into glycolic acid and the resulting mixture contains glycolic acid, aqueous liquid, nanoparticles and PFOS. PFOS contained in the mixture is then destroyed by sonolysis.

### Prophetic Example 2

Another exemplary degradable adsorbent includes a non-woven textile of polylactic acid (PLA) as the polymeric substrate and selenium nanoparticles. The degradable adsorbent is immersed in an aqueous liquid containing mercury (Hg). The immersion process results in adsorption of Hg onto the nanoparticles producing loaded adsorbent and concentration of Hg in the degradable adsorbent. The PLA non-woven is hydrolyzed by placing the loaded absorbent in water at a temperature of 100° C. The PLA non-woven disintegrates into lactic acid and the resulting mixture contains the lactic acid, aqueous liquid, nanoparticles and concentrated Hg. The mixture is then incinerated followed by sulfurization and solidification for appropriate disposal of Hg.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A degradable adsorbent, comprising:
a porous degradable polymeric substrate; and
nanoparticles bound to the porous degradable polymeric substrate.

2. The degradable adsorbent of claim 1, wherein the porous degradable polymeric substrate comprises a polymer selected from the group consisting of polyvinyl alcohol, polyester, polyurethane, and combinations thereof.

3. The degradable adsorbent of claim 2, wherein the polyester is selected from the group consisting of polyglycolic acid (PLA), polylactic acid (PGA), polylactic-co-glycolic acid (PLGA), polyhydroxyalkanoates (PHA), and combinations thereof.

4. The degradable adsorbent of claim 1, wherein the porous polymeric substrate has a structure selected from the group consisting of a sheet, a film, a tube, a foam, particulates, a textile, and combinations thereof.

5. The degradable adsorbent of claim 1, wherein the nanoparticles comprise a material selected from the group consisting of metals, non-metals, metal oxides, non-metal oxides, and combinations thereof.

6. The degradable adsorbent of claim 1, wherein the nanoparticles have a diameter in a range from 5 to 1000 nm.

7. The degradable adsorbent of claim 1, wherein the porous polymeric substrate has a porosity in a range from 5% to 99%.

8. A method for removing an impurity from a fluid, the method comprising:
immersing a degradable adsorbent in the fluid comprising the impurity;
adsorbing the impurities in the degradable adsorbent; and
disintegrating the degradable adsorbent in an aqueous solvent to produce a mixture comprising the aqueous solvent, a degraded substrate and the impurity,
wherein:
the degradable adsorbent comprises a porous degradable polymeric substrate, and
nanoparticles bound to the porous degradable polymeric substrate.

9. The method of claim 8, further comprising:
separating the impurity from the mixture.

10. The method of claim 9, further comprising:
collecting the impurity.

11. The method of claim 9, further comprising:
destroying the impurity.

12. The method of claim 8, further comprising:
collecting the impurity.

13. The method of claim 8, further comprising:
destroying the impurity.

14. The method of claim 8, wherein the impurity is a pollutant.

15. The method of claim 8, wherein the impurity is selected from the group consisting of organic materials, inorganic materials, and combinations thereof.

16. The method of claim 15, wherein the organic materials are selected from the group consisting of polyfluoroalkyl substances, polychlorinated biphenyl, bisphenol A, and combinations thereof.

17. The method of claim 15, wherein the inorganic materials are selected from the group consisting of lithium, mercury, lead, arsenic, cadmium, chromium and combinations thereof.

18. The method of claim 8, wherein the porous degradable polymeric substrate comprises a polymer selected from the group consisting of polyvinyl alcohol, polyester, polyurethane, and combinations thereof.

19. The method of claim 18, wherein the degradable polyester is selected from the group consisting of polyglycolic acid (PLA), polylactic acid (PGA), polylactic-co-glycolic acid (PLGA), polyhydroxyalkanoates (PHA), and combinations thereof.

20. The method of claim 8, wherein the nanoparticles comprise a material selected from the group consisting of metals, non-metals, metal oxides, non-metal oxides, and combinations thereof.

21. The method of claim 8, wherein the disintegrating comprises hydrolyzing the degradable adsorbent in the aqueous solvent.

22. The method of claim 21, wherein the hydrolyzing is conducted at a temperature in range from 30° C. to 300° C.

23. The method of claim 8, wherein the disintegrating comprises exposing the degradable adsorbent to a kinetic energy source.

24. The method of claim 8, wherein the disintegrating comprises exposing the degradable adsorbent to a microorganism.

25. The method of claim 8, wherein the disintegrating comprises oxidizing the degradable adsorbent.

26. The method of claim 8, wherein the disintegrating comprises completely disintegrating the degradable adsorbent.

27. The method of claim 8, wherein the disintegrating comprises partially disintegrating the degradable adsorbent.
